(19) United States
(12) Patent Application Publication
(10) Pub. No.: US 2008/0291811 A1
(43) Pub. Date: Nov. 27, 2008

(54) OPTICAL INFORMATON RECORDING MEDIUM AND METHOD FOR MAKING THE SAME

(75) Inventors: Fumi Hara, Gunma (JP); Takeshi Otsu, Gunma (JP); Isao Matsuda, Gunma (JP); Shingo Katoh, Takasaki-shi (JP); Masashi Satoh, Takasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 12/124,090

(22) Filed: May 20, 2008

(30) Foreign Application Priority Data
May 21, 2007 (JP) 2007-133811

(51) Int. Cl. G11B 7/24

(52) U.S. Cl. 369/275.3

(57) ABSTRACT

An optical information recording medium that has satisfactory main information recording characteristics and in which burst cutting area (BCA) marks can be formed without damaging a protective layer or a light-transmitting layer is provided. In forming the light-reflecting layer by vapor deposition, sputtering, ion-plating, or the like, part of the region is masked so as to make the thickness and/or material of the light-reflecting layer in a main information recording region where main information is recorded different from that of the light-reflecting layer in a BCA equivalent region. As a result, burst cutting of the light-reflecting layer in the BCA equivalent region becomes easier than in the main information recording region.

### BACKGROUND OF THE INVENTION

1. Field of the Invention

The present invention relates to disk-shaped optical information recording media and methods for making such media. In particular, it relates to an optical information recording medium in which management information is recorded in barcodes in addition to user information and to a method for making the optical information recording medium.

2. Description of the Related Art

In recent years, higher information recording density has been required in order to record high-definition image data. There has been suggested an optical information recording medium that includes a resin substrate 1.1 mm in thickness, a light-reflecting layer and a recording layer formed on a light incidence side of the resin substrate, and a light-transmitting layer 0.1 mm in thickness formed, either directly or via a protective layer, on the surface on which the light-reflecting layer and the recording layer are formed. An example of this is a blu-ray disk (BD-R) that uses a laser beam of a shorter wavelength of 360 to 450 mm (e.g., about 405 nm).

An optical information recording medium of this type has a light-reflecting layer and a recording layer sequentially formed on a resin substrate 1.1 mm in thickness with a guiding groove (pre-groove) in the light incidence side, and a light-transmitting layer 0.1 mm in thickness composed of a light-transmitting resin formed thereon so that the resulting optical information recording medium has the same diameter and thickness as those of CD-Rs and DVD±Rs. In some cases, a protective layer composed of an inorganic light-transmitting material is provided between the recording layer and the light-transmitting layer to protect the recording layer. The recording layer of the optical information recording medium is composed of an organic substance containing a colorant such as an azo or cyanine colorant, or an inorganic substance such as Si, Cu, Sb, Te, Ge, or the like. Data is recorded by irradiating the recording layer with a recording laser beam to thereby form pits in the recording layer.

The optical information recording medium may be used as a medium for recording barcoded management information such as serial and lot numbers so that whether the optical information recording medium is an authorized product of the manufacturer or distributor can be identified. In particular, there has been proposed and put to practice a technique of recording marks in barcodes in a burst cutting area (BCA) of an optical information recording medium such as DVD-ROM (these marks are hereinafter also referred to as “BCA marks”) and reading the BCA marks with an optical head in a drive equipped for reading the optical information recording medium.

For example, Japanese Unexamined Patent Application Publication No. 2005-518055 discloses an optical information recording medium having a light-reflecting layer, a phase change recording layer, and a transparent layer disposed on a disk-shaped substrate having an outer diameter of 120 mm, an inner diameter of 15 mm, and a thickness of about 1.1 mm. This optical information recording medium has a BCA region 101, which is the region in which BCA marks are recorded, located in the range between 21 mm and 22 mm from the disk center; a read-only region in the range extending from 22.4 mm to 23.2 mm from the disk center; and a read-write region in the range extending from 23.2 mm to 58.6 mm from the disk center. The laser beam having a wavelength of about 405 nm is applied from the optical head from the transparent layer side to record the user information on the read-write region. In forming the BCA marks, a high-output red laser having a wavelength of about 650 nm and a laser power of about 900 mW is used. In the sites irradiated with the laser beam, the phase change recording layer and the light-reflecting layer are burnt out by this laser beam so that the reflectance at these sites are close to 0%.

Japanese Unexamined Patent Application Publication No. 2006-85791 also discloses formation of a BCA area in an optical information recording medium, but an irreversible colorant recording layer is provided instead of the rewritable phase change recording layer described above. In particular, a light-absorbing layer containing a colorant and a light-reflecting layer are formed on a light-transmitting substrate having an outer diameter of 120 mm, an inner diameter of 15 mm, and a thickness of about 0.6 mm. The optical information recording medium has a BCA region in the range extending from 22.2 mm to 23.2 mm from the disk center, a management information region in the range extending from 23.4 mm to 23.8 mm from the center, and a user information region in the range extending from 23.8 mm to 58.5 mm from the center. This optical information recording medium is of an HD DVD-R type in which a laser beam having a wavelength of 400 nm to 420 nm is applied from the light-transmitting substrate side to record the user information in the user information region.

However, currently, the BCA marks are mostly formed by burst cutting whereby a laser beam is applied to an optical information recording medium after manufacture, i.e., the BCA marks are formed by fusing and perforating the light-reflecting layer. This inflicts significant damage on the protective layers and cover layers of the above-described blu-ray disks.

In particular, a silver-based reflecting film containing silver as the main component is usually used as the light-reflecting layer of a blu-ray disk since such a light-reflecting layer exhibits high reflectance for a blue laser beam. However, since the silver-based reflecting film has high thermal transmittance, a high laser power is required for marking, resulting in damage on the protective layer and the cover layer. It is possible to decrease the thermal conductivity of the light-reflecting layer or reduce the thickness of the reflecting layer so that the burst cutting can be performed with low power; however, this leads to degradation of characteristics in the normal recording area and reliability.

Japanese Unexamined Patent Application Publication Nos. 2006-202487 and 2006-294195 related to optical information recording media having BCA markings disclose a silver-based alloy for forming a reflective film that facilitates laser marking, i.e., a silver-based alloy having low thermal conductivity, low melting temperature, high corrosion resistance, high thermal resistance, and other desirable properties. However, these documents are directed to read-only dual-layer discs. As mentioned earlier, blu-ray discs suffer from degradation in properties in the normal recording area and reliability as the thermal conductivity of the light-reflecting layer is decreased. Thus, the silver alloys disclosed in these documents cannot be directly applied to blu-ray discs.

Japanese Unexamined Patent Application Publication No. 2005-196940 teaches an information recording medium having a first information recording layer in which barcoded marks are written and a second information recording layer. In this information recording medium, the thermal conductivity of the material of the second information recording layer is set to be at least 1.5 times greater than that of the material of the first information recording layer in which the barcode marks are written. According to this technology, an intermediate layer is interposed between the first information recording layer and the second information layer. In particular, this document relates to a read-only information recording medium in which BCA marks are recorded in a reflective film, which is the first information recording layer, and information is read from a light-reflecting layer, which is the second information recording layer.

Japanese Unexamined Patent Application Publication No. 2001-126325 teaches formation of barcodes not by burst cutting but by sputtering through masks. However, masks with a line width of about several tens of micrometers will be quickly filled in continuous production and frequent replacement of masks will be required, which is not practical.

As described above, a technology that can form BCA marks on a manufactured optical information recording medium without damaging the protective layer or cover layer has not been available so far.

### SUMMARY OF THE INVENTION

Accordingly, the present invention overcomes the above-described problems of blu-ray discs by providing an optical information recording medium in which BCA marks can be formed with a low laser power without damaging a protective layer or a light-transmitting layer and which exhibits satisfactory characteristics in recording main information. According to this invention, during formation of a light-reflecting layer by vapor deposition, sputtering, ion-plating, or the like, a certain region is masked. As a result, the thickness and/or material of the light-reflecting layer in a BCA equivalent region can be made different from those in a main information recording region for recording main information so that the characteristics are different between these two parts. Thus, burst cutting of the portion of the light-reflecting layer in the BCA equivalent region is easier than in the main information region.

A first embodiment of the present invention provides an optical information recording medium that includes a disk-shaped substrate having a main surface with a spiral groove; a light-reflecting layer disposed on the main surface of the substrate, the light-reflecting layer reflecting a laser beam and having a surface with a groove corresponding to the spiral groove of the disk-shaped substrate; an optical recording layer disposed on an upper surface of the light-reflecting layer, the optical recording layer containing a light-absorbing substance containing an organic colorant that absorbs a laser beam; a protective layer disposed on the optical recording layer; and a light-transmitting layer disposed on the protective layer. In this optical information recording medium, the optical recording layer has a main information region for recording main information that can be optically read by laser beam irradiation and a BCA equivalent region equivalent to a burst cutting area at an inner circumferential side of the main information region. Furthermore, at least one of the thickness and the material of the light-reflecting layer in the main information region is different from that of the light-reflecting layer in the BCA equivalent region.

According to this embodiment, a reflective film in which BCA marks can be formed without damaging the protective layer or the cover layer can be easily designed.

According to a second embodiment of the optical information recording medium, the light-reflecting layer is constituted by a first sublayer and a second sublayer. The first sublayer is provided over the BCA equivalent region and the main information region, and the second sublayer is not provided in the BCA equivalent region.

According to this embodiment, the light-reflecting layer includes two sublayers to record main information by laser irradiation from the light-transmitting layer side, i.e., the uppermost layer side. In the case where the first sublayer is composed of a material suited for burst cutting and the second sublayer (disposed only in the main information region) is composed of a material suited for formation of a total reflection layer, materials can be freely chosen since the first sublayer under the second sublayer does not affect recording of the main information.

In a further embodiment, in addition to the features described above in reference to the second embodiment, the first sublayer and the second sublayer of the light-reflecting layer are composed of the same material.

In another further embodiment, in addition to the features described above in reference to the second embodiment, the thermal conductivity of the first sublayer of the light-reflecting layer is smaller than the thermal conductivity of the second sublayer.

In an embodiment of the optical information recording medium according to the first embodiment, the thermal conductivity of the light-reflecting layer may be smaller in the BCA equivalent region than in the main information region.

In this embodiment of the optical information recording medium, the thickness of the light-reflecting layer may be smaller in the BCA equivalent region than in the main information region.

A third embodiment of the present invention provides a method for making the optical information recording medium according to any one of the preceding embodiments, the method including forming the light-reflecting layer by changing masked regions in at least two steps of vapor deposition, sputtering, ion-plating, or the like.

### BRIEF DESCRIPTION OF THE DRAWINGS

FIG. 1 is a plan view showing an overall structure of an optical information recording medium;

FIG. 2 is a partial enlarged cross-sectional view showing the region marked by a broken line in FIG. 1 and illustrates a general structure of the interior of the optical information recording medium;

FIG. 3 is a partial enlarged cross-sectional view showing the detailed structure of a groove 12;

FIG. 4 is a schematic diagram in the radial direction of the substrate, showing the range in which the first and second light-reflecting sublayers are formed; and

FIG. 5 is a schematic view in the radial direction of the substrate, showing the range in which the first and second light-reflecting sublayers of different materials are formed.

### DESCRIPTION OF CERTAIN EMBODIMENTS

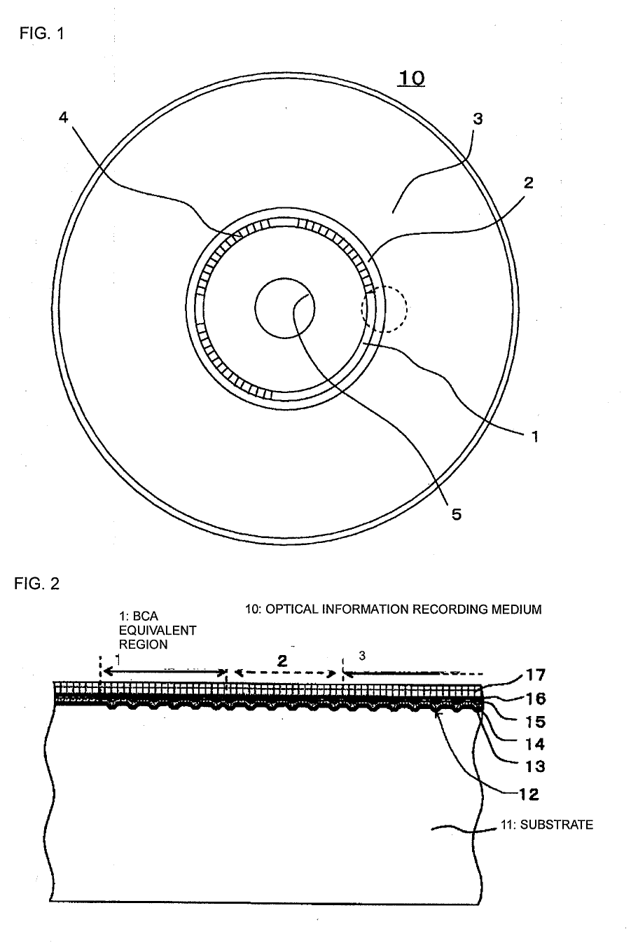

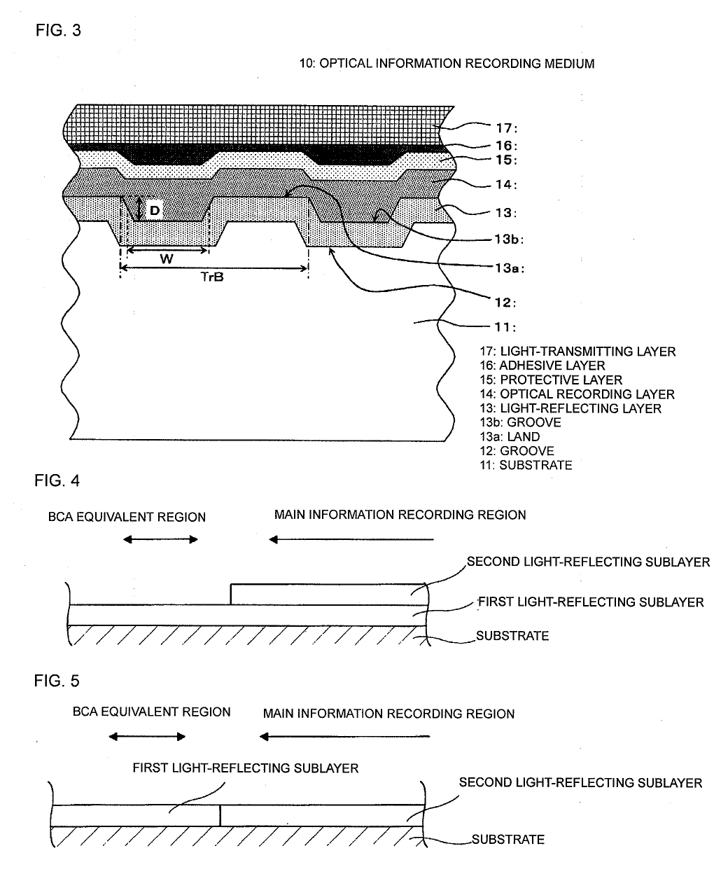

An optical information recording medium of the present invention will now be described with reference to FIGS. 1 to 3. FIG. 1 is a plan view showing an overall structure of an optical information recording medium 10 according to an embodiment of the present invention. FIG. 2 is a partial enlarged cross-sectional view showing the region marked by a broken line in FIG. 1 and illustrates a general structure of the interior. FIG. 3 is a partial enlarged cross-sectional view showing the detailed structure of a groove 12.

As shown in FIG. 1, the optical information recording medium 10 of this embodiment has a center hole 5 and is a disc having an outer diameter of about 120 mm, an inner diameter of about 15 mm, and a thickness of about 1.2 mm. A BCA equivalent region 1 having a groove (described below) formed at a track pitch of about 2.0 μm is formed in one main surface of the optical information recording medium 10 in the range extending from about 21.0 mm to about 22.1 mm from the center at the inner circumference side. BCA marks 4 are formed in the BCA equivalent region 1. A main information recording region 3 having a groove formed at a track pitch of about 0.32 μm is formed at the outer circumferential side of the BCA equivalent region 1 in the range extending from about 23.0 mm to about 58.5 mm from the center. The range extending from about 22.1 mm to about 23.0 mm from the center is an intermediate region 2 between the BCA equivalent region 1 and the main information recording region 3. The usage of the intermediate region 2 is not limited, and the intermediate region 2 may be a read-only region or a region a user can freely use. In particular, the intermediate region 2 may be a mirror region with no grooves or a disk information region with grooves.

The general structure of the interior of the optical information recording medium 10 in the region marked by the broken line in FIG. 1 is shown in the partial enlarged cross-sectional view in FIG. 2. As shown in the drawing, the optical information recording medium 10 is constituted by a disk-shaped substrate 11 having a thickness of about 1.1 mm with a spiral groove 12 formed in one main surface; a light-reflecting layer 13 that reflects a laser beam; an optical recording layer 14 that contains a light-absorbing substance composed of an organic colorant that absorbs the laser light; a protective layer 15; an optional adhesive layer 16; and a light-transmitting layer 17 having a thickness of about 0.1 mm, sequentially disposed in that order on the main surface of the optical information recording medium 10.

As shown in FIG. 3, a surface on the light incidence side of the light-reflecting layer 13 on the groove 12 of the substrate 11 has a spiral groove 13b corresponding to the groove 12, the spiral groove 13b having a track pitch of TrB, and a land 13a adjacent to the groove 13b.

The track pitch TrB of the groove 13b is preferably in the range of about 200 nm to about 400 nm, more preferably in the range of about 250 nm to about 350 nm, for example 320 nm. A depth D of the groove 13b is preferably in the range of about 20 nm to about 150 nm, for example 45 nm. A groove width W of the groove 13b is preferably about 50 nm to about 250 nm, more preferably 100 to 200 nm, for example 170 nm.

The main information recording region 3 is irradiated with a laser beam having a wavelength of about 400 nm to about 420 nm (405 nm for example) based on recording information to record optically readable main information on the optical recording layer 14. A BCA equivalent region 1 for recording a side information including BCA marks 4 of a type different from the main information is provided at the inner peripheral side of the main information recording region 3.

In this embodiment, any of various materials that have been used as the substrate materials for optical information recording media may be used in the substrate 11. Examples of the material include polycarbonate, acrylic resins such as polymethyl methacrylate, vinyl chloride-resins such as polyvinyl chloride and vinyl chloride copolymers, epoxy resins, amorphous polyolefin, polyester resins, metals such as aluminum, and glass. These materials may be used alone or in combination. Among these, thermoplastic resins are preferred for their moldability, moisture resistance, dimensional stability, and low cost. In particular, polycarbonates are preferred.

In using these resins, an injection molding technique or other suitable techniques may be employed to form the substrate 11 having a particular shape (disk shape if an optical disk is to be produced). The thickness of the substrate 11 is preferably in the range of about 0.9 mm to about 1.1 mm. The material is not limited to those described above. For example, a UV-curable resin may be applied on a base and then cured.

In this embodiment the spiral groove 12 is preferably formed in the BCA equivalent region 1 at the inner circumferential side of the main surface of the substrate 11 and in the main information recording region 3 at the outer circumferential side.

The groove 12 may be formed during injection molding of the substrate 11 by placing inside the mold for injection molding a micromachined mold plate called a “stamper” having a spiral protrusion with a shape inversely corresponding to the groove 12 in one of the main surfaces.

The light-reflecting layer 13 of this embodiment reflects a laser beam for data recording or reading. The light-reflecting layer 13 is provided between the substrate 11 and the optical recording layer 14 to increase the reflectance for the laser beam and to improve the read/write characteristics. For example, the light-reflecting layer 13 is formed by vapor deposition, ion-plating, sputtering, or other appropriate processes on the surface of the substrate 11 where the groove 12 is formed. In particular, sputtering is preferred due to its mass productivity and cost.

In this embodiment, at least one of a thickness and a material of the light-reflecting layer 13 corresponding to the BCA equivalent region 1 is different from the light-reflecting layer 13 corresponding to the main information recording region 3. In this manner, burst cutting of the portion of the light-reflecting layer 13 in the BCA equivalent region 1 is easier than in the main information recording region 3.

One approach for making burst cutting of the portion of the light-reflecting layer 13 in the BCA equivalent region 1 easier than in the main information recording region 3 is to decrease the thickness of the light-reflecting layer 13 in the BCA equivalent region 1 so that the thickness in the BCA equivalent region 1 is smaller than the thickness in the main information recording region 3.

In particular, during formation of the light-reflecting layer 13 by vapor deposition, sputtering, ion-plating, or the like, a first light-reflecting sublayer 13′ is formed over the BCA equivalent region 1 and the main information recording region 3 and then a second light-reflecting sublayer 13″ is formed while masking the BCA equivalent region 1. FIG. 4 is a schematic diagram in the radial direction of the substrate, showing the range in which the first and second light-reflecting sublayers are formed. The left-hand side of the drawing is the inner circumferential side of the disc, and the right-hand side of the drawing is the outer circumferential side of the disc.

As shown in FIG. 4, by the process described above, only the first light-reflecting sublayer 13′ is formed in the BCA equivalent region 1 and both the first and second light-reflecting sublayers 13′ and 13″ are formed in the main information recording region 3. In other words, the thickness of the light-reflecting layer 13 in the BCA equivalent region 1 is smaller than in the main information recording region 3; hence, the laser power required for formation of BCA marks can be reduced and the main information recording region 3 can be ensured to have a thickness sufficient for total reflection.

If the difference in thickness between the first light-reflecting sublayer and the second light-reflecting sublayer is sufficiently large, these two sublayers may be composed of the same material. Alternatively, the first light-reflecting sublayer may be composed of a material having thermal conductivity lower than that of the material of the second light-reflecting sublayer so that the satisfactory characteristics are exhibited in both BCA recording and main information recording.

Another approach for making burst cutting of the light-reflecting layer 13 in the BCA equivalent region 1 easier than in the main information recording region 3 is to use different materials in the portion of the light-reflecting layer 13 in the BCA equivalent region 1 and the portion of the light-reflecting layer 13 in the main information recording region 3 so that the thermal conductivity of the light-reflecting layer 13 in the BCA equivalent region 1 is lower than that in the main information recording region 3.

In particular, the main information recording region 3 is masked with an inner mask and a first light-reflecting sublayer is formed using a material having low thermal conductivity in the BCA equivalent region 1 only. The inner mask is then replaced with an inner mask for masking the BCA equivalent region 1 and a second light-reflecting sublayer is formed using a material having higher thermal conductivity in the main information recording region 3 only.

FIG. 5 is a schematic view in the radial direction of the substrate, showing the range in which the first and second light-reflecting sublayers of different materials are formed. The left-hand side is the inner circumferential side of the disc, and the right-hand side is the outer circumferential side of the disc.

As shown in FIG. 5, according to this second approach, the portion of the light-reflecting layer 13 corresponding to the BCA equivalent region 1 has low thermal conductivity and the portion of the light-reflecting layer 13 corresponding to the main information recording region 3 has a higher thermal conductivity.

Accordingly, the laser power required for formation of the BCA marks can be reduced, and a light-reflecting layer having thermal conductivity sufficiently high for satisfactory recording characteristics can be formed in the main information recording region 3.

Accordingly, as long as the difference in thermal conductivity between the first light-reflecting sublayer and the second light-reflecting sublayer is sufficiently large, the two sublayers may have the same thickness. Alternatively, the first approach of changing the thickness between the light-reflecting sublayers may be combined with the second approach so that the portion of the light-reflecting layer 13 in the BCA equivalent region 1 composed of the material having low thermal conductivity is made thinner than the portion of the light-reflecting layer 13 in the main information recording region 3 composed of the material having high thermal conductivity. In this manner, satisfactory characteristics are exhibited in both BCA recording and main information recording.

The material of the portion of the light-reflecting layer 13 in the main information recording region 3 may be any material that is commonly used in regular blu-ray discs. Preferable examples thereof include metal films such as Au, Al, Ag, Cu, and Pd films and alloy films of these metals with or without minor components. The portion of the light-reflecting layer 13 in the BCA equivalent region 1 is preferably composed of a material having low thermal conductivity. Examples thereof include Ag alloys and Al alloys.

In this embodiment, the optical recording layer 14 preferably contains a light-absorbing substance containing an organic colorant that absorbs a laser beam. For example, a colorant-type optical recording layer in which data is recorded by formation of pits by laser beam irradiation may be used. The organic colorant may be a phthalocyanine colorant, a cyanine colorant, an azo colorant, or the like. The optical recording layer 14 may be formed by dissolving an azo colorant represented by chemical formula 1 or a cyanine colorant represented by chemical formula 2 and a binder in a solvent, e.g., tetrafluoropropanol (TFP), to prepare a coating solution; applying the coating solution by spin coating, screen-printing, or the like through the light-reflecting layer to form a coating film; and drying the coating film at, for example, 80° C. for about 30 minutes:

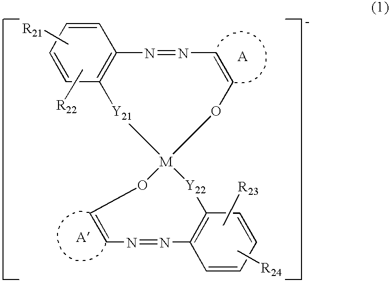

(wherein A and A′ each contain at least one heteroatom selected from the group consisting of nitrogen, oxygen, sulfur, selenium, and tellurium atoms and represent the same or different heterocyclic rings; R₂₁ to R₂₄ each independently represent a hydrogen atom or a substituent; and Y₂₁ and Y₂₂ each represent a heteroatom selected from Group 16 elements in the periodic table and may be the same or different), and

$${Φ}^{⊕} - L = ∮ {( {X}^{⊖} )}_{m} \qquad ( 2 )$$

(wherein Φ⁺ and φ each represent an indolenine ring residue, a benzoindolenine ring residue, or dibenzoindolenine ring residue; L represents a linking group for forming a mono- or dicarbocyanine colorant; X⁻ represents an anion; and m represents 0 or 1).

In this embodiment, the protective layer 15 is preferably formed between the optical recording layer 14 and the light-transmitting layer 17 described below to adjust the recording characteristics and the like, improve the adhesiveness, or protect the optical recording layer 14.

The protective layer 15 may be a transparent film composed of SiO₂, ZnS—SiO₂, Nb₂O₅—Al₂O₃, or the like and may be formed by vapor deposition, ion-plating, sputtering, or the like on the surface where the optical recording layer 14 is formed. In particular, sputtering is preferred due to its mass productivity and cost.

In this embodiment, the adhesive layer 16 is an optional layer used for improving the adhesiveness between the protective layer 15 and the sheet-shaped transparent light-transmitting layer 17 described below.

The adhesive layer 16 may be mainly composed of a transparent reactive curable resin such as an epoxy resin or a transparent UV curable resin. The resin is applied on the protective layer 15 and/or the lower surface of the sheet-shaped light-transmitting layer 17 having a thickness of about 0.1 mm described below, by spin coating, screen-printing, or another suitable process; and the protective layer 15 of the substrate 11 is bonded to the sheet-shaped light-transmitting layer 17 with the adhesive layer 16. As a result, a disk-shaped optical information recording medium having a thickness of about 1.2 mm is obtained.

In this embodiment, the light-transmitting layer 17 may be composed of a transparent resin. For example, a sheet composed of a resin having high light transmittance such as a polycarbonate resin or an acrylic resin is used. Alternatively, the light-transmitting layer 17 may be formed by an application technique using any of these resins.

The thickness of the light-transmitting layer 17 is usually preferably 0.1 mm so as to allow the data to be read from and/or written on the optical recording layer 14 by irradiation with the laser beam having a wavelength of about 400 to 420 nm.

Specific examples of a method for forming the light-transmitting layer 17 are described below but should not be understood as limiting the range of the present invention:

(A) applying a UV-curable adhesive mainly composed of an acrylic resin on the substrate with the protective layer formed thereon, bonding a disk-shaped sheet composed of a polycarbonate resin about 0.1 mm in thickness, irradiating the adhesive with UV light so as to cure the adhesive and to thereby prepare a disk-shaped optical information recording medium having a thickness of about 1.2 mm;

(B) bonding a light-transmitting layer constituted by a polycarbonate sheet about 0.1 mm in thickness on the substrate with the protective layer thereon with a transparent pressure-sensitive adhesive to thereby prepare a disk-shaped optical information recording medium having a thickness of about 1.2 mm; and

(C) applying a resin mainly composed of an acrylic resin by spin-coating on a substrate with the protective layer formed thereon and curing the resin by UV irradiation to form a cover layer having a thickness of about 0.1 mm and to thereby prepare a disk-shaped optical information recording medium having a thickness of about 1.2 mm.

### EXAMPLES

The present invention will now be described more specifically by way of examples which do not limit the scope of the present invention in any way.

### Example 1

### Production of Substrate

A photoresist (sensitizer) was applied on a glass master to a predetermined thickness so as to form a resist film, and the resist film was exposed with a laser beam of a cutting apparatus into a predetermined exposure width. A developer was dropped on the resulting glass master to form by development a resist pattern having a groove corresponding to the groove of the substrate of the disk-shaped optical information recording medium.

Nickel was deposited on the resulting glass master by plating and was separated. The separated nickel was trimmed into a disk-shaped appearance to obtain a stamper.

The stamper was loaded inside the cavity of an injection molding apparatus and a polycarbonate resin was injected into the cavity to prepare a substrate having a spiral groove in one of the main surfaces.

### Formation of Light-Reflecting Layer

Sputtering was conducted on the main surface with the spiral groove by using a sputtering device, an inner mask having a diameter of 34.0 mm, and a Ag-0.65Cu-1.0In (wt %) silver alloy (thermal conductivity: 1.03 W/K cm) as a target material so that the deposited layer had a uniform thickness. As a result, a first light-reflecting sublayer 13′ having a thickness of 20 nm was formed in the region extending outward from the position 17 mm from the disc center in the radial direction.

The inner mask was replaced with another inner mask having a diameter of 44.3 mm and sputtering was conducted using the same material. As a result, a second light-reflecting sublayer 13″ having a thickness of 80 nm was formed in the region extending outward from the position 22.15 mm from the disc center in the radial direction (the total thickness of the two sublayers was 100 nm).

It should be noted here that in a normal disc, the range extending from 21.00 mm to 22.01 mm from the center in the radial direction is defined as the BCA equivalent region; however, actual measurement showed that BCA equivalent region was in the range of 21.19 to 22.08 mm. Although the boundary to the main information recording region 3 was unclear, there was no particular disadvantage since the range extending from 22.1 mm to 23.0 mm from the center was read-only.

### Formation of Recording Layer, Protective Layer, and Light-Transmitting Layer

A colorant solution containing an azo organic colorant represented by chemical formula 1 above was applied by spin-coating on the substrate to a thickness of 60 nm.

A protective film having a thickness of 25 mm was then formed by sputtering ZnS—SiO₂ on the resulting substrate by using a sputtering device.

A UV-curable adhesive mainly composed of an acrylic resin was applied on the resulting substrate, a disk-shaped polycarbonate resin sheet having a thickness of 0.1 mm was bonded onto the substrate, and UV irradiation was conducted to cure the adhesive and to thereby prepare a disk-shaped optical information recording medium having a thickness of about 1.2 mm.

### Formation of BCA Marks

BCA marks 4 having a circumferential width of 10 μm were formed in the BCA equivalent region of the optical information recording medium with a BCA cutting machine applying an elliptic spot (minor axis: about 0.85 μm, major axis: about 35 μm) elongated in the disk radial direction and having a laser wavelength of 810 nm. The laser bias power was 200 mW, the cutting rate was 1000 rpm, the beam feed ratio in the radial direction was 6 μm, the recording start position was 21.0 mm, and the recording end position was 22.0 mm. A disk-shaped optical information recording medium was obtained as a result.

The power required for formation of the BCA marks in the optical information recording medium was 3000 mW. After formation of the BCA marks, the optical information recording medium was investigated. There was no damage on the protective layer or the light-transmitting layer, and satisfactory BCA marks were formed.

### Example 2

An optical information recording medium was prepared as in Example 1 except that the material for forming the first light-reflecting sublayer 13′ was changed to a Ag-0.95Bi-3.95Nd (wt %) silver alloy (thermal conductivity: 0.4 W/K cm). This material had a thermal conductivity lower than the Ag-0.65Cu-1.0In (wt %) silver alloy.

The power required for formation of the BCA marks in the optical information recording medium was 2000 mW. After formation of the BCA marks, the optical information recording medium was investigated. There was no damage on the protective layer or the light-transmitting layer, and satisfactory BCA marks were formed.

### Example 3

An optical information recording medium was prepared as in Example 1 except that formation of the light-reflecting layer was changed as follows:

In forming the light-reflecting layer as in Example 1, an inner mask having a diameter of 34.0 mm and a doughnut-shaped inner mask having a diameter of 44.3 mm were used, and a Ag-0.95Bi-0.92Nd-6.47Sn (wt %) silver alloy (thermal conductivity: 0.26 W/K cm) as a target material was sputter-deposited to form a layer having a uniform thickness with each mask. As a result, a first light-reflecting sublayer having a thickness of 60 nm was formed in the range extending from 17 mm to 22.15 mm from the disk center in the radial direction. Then, the inner mask was changed to an inner mask having a diameter of 44.3 mm, and sputtering was conducted using a Ag-0.65Cu-0.2In (wt %) silver alloy (thermal conductivity: 1.53 W/K cm) as the target material. As a result, a second light-reflecting sublayer having a thickness of 100 nm was formed in the range extending outward from the position 22.15 mm from the disk center in radial direction.

The power required for formation of the BCA marks in the optical information recording medium was 2000 mW. The optical information recording medium after formation of BCA marks was investigated. There was no damage on the protective layer or the light-transmitting layer, and satisfactory BCA marks were formed.

### Example 4

An optical information recording medium was formed as in Example 3 except that the material of the first light-reflecting sublayer was changed to an Al-24.3Nd-5.1Ta (wt %) aluminum alloy (thermal conductivity: 0.18 W/K cm) and the thickness of the second light-reflecting sublayer was changed to 60 nm.

The power required for formation of the BCA marks in this optical information recording medium was 1000 mW. The optical information recording medium after formation of the BCA marks was investigated. There was no damage on the protective layer or the light-transmitting layer, and satisfactory BCA marks were formed.

### COMPARATIVE EXAMPLE

An optical information recording medium was formed as in Example 1 except that the light-reflecting layer was formed in one step as below.

Sputtering was conducted by using an inner mask 34.0 mm in diameter and a Ag-0.65Cu-0.2In (wt %) silver alloy (thermal conductivity: 1.53 W/K cm) as a target material so as to form a layer with a uniform thickness. As a result, a light-reflecting layer 13 having a thickness of 60 nm was formed in the range extending outward from the position 17 mm from the disk center in the radial direction.

The power required for forming the BCA marks in this optical information recording medium was 5000 mW. The optical information recording medium after formation of the BCA marks was investigated. The protective layer and the light-transmitting layer were damaged, and the objective of the present invention could not be achieved.

The structure and the operation of the present invention are not limited to the above descriptions. Various modifications may be made without departing from the spirit and scope of the present invention. While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. An optical information recording medium comprising:
a disk-shaped substrate having a main surface with a spiral groove;
a light-reflecting layer disposed on the main surface of the substrate, the light-reflecting layer configured to reflect a laser beam and having a surface with a groove corresponding to the spiral groove of the disk-shaped substrate;
an optical recording layer disposed on the surface of the light-reflecting layer having the groove, the optical recording layer comprising a light-absorbing substance containing an organic colorant;
a protective layer disposed on the optical recording layer; and
a light-transmitting layer disposed on the protective layer,
wherein the optical recording layer comprises a main information region for recording main information that can be optically read by laser beam irradiation, and a BCA equivalent region equivalent to a burst cutting area at an inner circumferential side of the main information region, and
wherein at least one of a thickness and a material of the light-reflecting layer in the main information region is different from that of the light-reflecting layer in the BCA equivalent region.

2. The optical information recording medium according to claim 1, wherein the light-reflecting layer comprises a first sublayer and a second sublayer;
wherein the first sublayer is provided over the BCA equivalent region and the main information region; and
wherein the second sublayer is not provided in the BCA equivalent region.

3. The optical information recording medium according to claim 2, wherein a thickness of the first sublayer is about 60 nm and a thickness of the first and second sublayer combined is about 100 nm.

4. The optical information recording medium according to claim 2, wherein the first sublayer and the second sublayer of the light-reflecting layer are composed of the same material.

5. The optical information recording medium according to claim 4, wherein the first and second sublayers comprise an Ag-0.65Cu-1.0In silver alloy.

6. The optical information recording medium according to claim 2, wherein a thermal conductivity of the first sublayer of the light-reflecting layer is smaller than a thermal conductivity of the second sublayer.

7. The optical information recording medium according to claim 6, wherein the first sublayer comprises an Ag-0.95Bi-3.95Nd silver alloy and the second sublayer comprises an Ag-0.65Cu-1.0In silver alloy.

8. The optical information recording medium according to claim 1, wherein a thermal conductivity of the light-reflecting layer is smaller in the BCA equivalent region than in the main information region.

9. The optical information recording medium according to claim 8, wherein a thickness of the light-reflecting layer is smaller in the BCA equivalent region than in the main information region.

10. The optical information recording medium according to claim 1, wherein the light-reflecting layer in the main information region comprises an Ag-0.65Cu-0.2In silver alloy and the light-reflecting layer in the BCA equivalent region comprises an Ag-0.95Bi-0.92Nd-6.47Sn silver alloy.

11. The optical information recording medium according to claim 1, wherein the light-reflecting layer in the main information region comprises an Ag-0.65Cu-0.2In silver alloy and the light-reflecting layer in the BCA region comprises an Al-24.3Nd-5.1Ta aluminum alloy.

12. A method for making an optical information recording medium, the method comprising:
forming a light-reflecting layer on a main surface of a disk-shaped substrate with a spiral groove such that the light-reflecting layer comprises a surface with a groove corresponding to the spiral groove of the disk-shaped substrate;
forming an optical recording layer on the surface of the light-reflecting layer having the groove using a substance containing an organic colorant capable of absorbing a laser beam;
forming a protective layer on the optical layer; and
forming a light-transmitting layer on the protective layer,
wherein forming the light-reflecting layer comprises changing masked regions in at least two steps to form a first portion of the light-reflecting layer corresponding to a main information region of the optical recording layer and a second portion of the light-reflecting layer equivalent to a burst cutting area at an inner circumferential side of the main information region, and
wherein at least one of a thickness and a material of the first portion is different from that of the second portion.

13. The method of claim 12, wherein the forming the light-reflective layer comprises vapor depositing, sputtering, or ion-plating.

14. The method of claim 12, further comprising forming BCA marks in the second portion of the light-reflecting layer.

15. The method of claim 12, wherein the forming the light reflecting layer comprises:
sputtering using an inner mask of a first diameter; and
sputtering using an inner mask of a second diameter, the second diameter being larger than the first diameter.

16. The method of claim 15, wherein the first diameter is approximately equal to an inside diameter of the second portion, and wherein the second diameter is approximately equal to an inside diameter of the first portion.

17. The method of claim 12, wherein the forming the light reflecting layer comprises:
sputtering using an inner mask of a first diameter and a doughnut-shaped inner mask of a second diameter, the second diameter being larger than the first diameter; and
sputtering using an inner mask of the second diameter.

18. The method of claim 17, wherein the first diameter is approximately equal to an inside diameter of the second portion, and wherein the second diameter is approximately equal to an inside diameter of the first portion.

19. The method of claim 12, further comprising forming an adhesive layer between the protective layer and the light-transmitting layer.
